(19) United States
(12) Patent Application Publication
(10) Pub. No.: US 2004/0206822 A1
(43) Pub. Date: Oct. 21, 2004

(54) Combination smart card-barcode reader

(76) Inventor: Toby Crandall, Berryville, VA (US)

Correspondence Address: NATIONAL IP RIGHTS CENTER, LLC, SCOTT J. FIELDS, ESQ., 550 TOWNSHIP LINE ROAD, SUITE 400, BLUE BELL, PA, 19422, US

(21) Appl. No.: 10/417,409

(22) Filed: Apr. 16, 2003

(51) Int. Cl. G06K 7/10; G06K 15/00

(52) U.S. Cl. 235/462.13

(57) ABSTRACT

An apparatus for reading and storing barcodes on a smart card comprising, a housing unit containing therein; activation means for turning the unit on; barcode reading means for reading a barcode into the unit; means for storing the barcodes; and means for writing the barcodes so stored in the unit onto a smart card.

### FIELD OF THE INVENTION

The present invention is directed to the field of barcode readers and smart card readers. In particular, the present invention is directed to systems which read and store barcodes and which can store and copy the same to a smart card.

### BACKGROUND OF THE INVENTION

Coupons, premiums and loyalty programs have become extremely popular in the last ten years. In addition, with the universal rise in the use of barcodes on all manner of products, there has arisen an opportunity for vendors to combine the attributes of barcode technology with smart cards. A number of patents have issued related to barcode and/or smart card technology. None are directed to a combination barcode and smart card reader.

U.S. Pat. No. 5,664,110 to Green et al. and assigned to Highpoint Systems, Inc. discloses this patent is a remote ordering system which provides a user the ability to build and edit one or more order lists, resident in memory within a user device, and the further ability to review and manipulate a user interpretable display of the contents of such lists. The system comprises merchant stock databases, and a data format/transfer computer (DFTC). A display/processor units (DPUs) (the user devices) enables creation and transmission of the order lists. Coded data read into each DPU identifies items to be added to the order lists. A DPU database contains user-discernable item information stored according to the associated coded data and is capable of learning new or updating old item information when in communication with the merchant database. Item information can be automatically or manually deleted to free DPU memory.

U.S. Pat. No. 6,000,612 to Xu assigned to Metanetics Corporation is directed to a portable database collection device for providing optical character recognition. A housing defines an internal region and includes a user handle that allows a user to position the housing relative to an indicia carrying target. An imaging assembly includes a two dimensional imaging array supported within the internal region of the housing. The imaging assembly includes a capture circuit that generates a video signal representative of an image of a target zone. An optics assembly supported by the housing focuses an image of the target area onto the photosensor array. A character recognition processing circuit receives the video signal and categorizes the indicia on the target into a set of predefined characters. The character recognition processing circuit includes a discriminator for identifying a text region of the target and identifying individual character regions within the text region and a categorizer for identifying a character from a set of possible characters for an individual character region. The categorizer performs one or more tests based on pixel data within the individual character region.

U.S. Pat. No. 6,405,049 is directed to a portable data device system and includes a portable data device and a cradle for receiving the portable data device. The cradle is arranged to recharge the portable data device power supply and/or upload or download information to and from the portable data device. The cradle and portable data device are in wireless communication allowing a minimum of processing and data storage capability at the front end and hence operation of the portable data device as a thin client.

None of the prior art systems disclose a simple system by which barcoded products could be read and transferred onto a smart card for use by retailers, vendor and purveyors of products. Such a system would enable individual merchants, vendors, and retailers of all size to provide loyalty and premium programs to their customers or to combine them with programs offered by other vendors.

It is therefore an object of the present invention to provide a simple electronic unit by which product barcodes could be quickly read or input or stored on a smart card.

It is a further object of the present invention to provide such a system for facilitating a loyalty program, premium program and other promotions by retailers, e-tailers and vendors.

It is a further object of the present invention to provide a system by which such smart cards could readily be used for such programs via kiosks, PCs and PDAs. Such a system would allow end users to conveniently and rapidly take advantage of coupons and premiums.

It is a further object of the present invention to provide a system which is applicable to inventory control.

These and other objects and features of the present invention are set forth in more particularity in the attached detailed description and claims which follow.

### SUMMARY OF THE INVENTION

In accordance with the present invention an apparatus for reading and storing barcodes on a smart card comprising, a housing unit containing therein; activation means for turning the unit on; barcode reading means for reading a barcode into the unit; means for storing the barcodes; and means for writing the barcodes so stored in the unit onto a smart card.

In a further embodiment, the present invention is a system for reading a barcode and storing the same onto a smart card comprising; a barcode reader module for reading a barcode; a smart card module including a card interface for transcribing a barcode read from said barcode reader module onto a smart card; and a microcontroller under the control of interface and control logic for reading said barcode, storing same; and means for writing said barcode onto said smart card.

In a further embodiment of the present invention, a system for reading a barcode and storing the same onto a smart card comprising; a barcode reader module for reading a barcode; a smart card module including a card interface for transcribing a barcode read from said barcode reader module onto a smart card; and a microcontroller under the control of interface and control logic for reading said barcode, storing same; and means for writing said barcode onto said smart card.

### BRIEF DESCRIPTION OF THE FIGURES

FIGS. 1 and 2 are block diagrams of a preferred embodiment of the present invention.

FIG. 3 is a prospective view of the barcode/smart card storage and retrieval system of the present invention.

FIGS. 4 and 5 comprise detailed schematics of preferred embodiments of the present invention.

FIGS. 6 and 7 comprise respective PC and kiosk activated smart card activation systems of the present invention.

### DETAILED DESCRIPTION OF THE INVENTION

The present invention is described with reference to the attached Figures wherein the same numbers are utilized where applicable. In the broadest embodiment, the invention is directed to a combination smart card/barcode storage and retrieval unit. In one embodiment, the invention is a single unit, which may be handheld that integrates both smart card and barcode technologies.

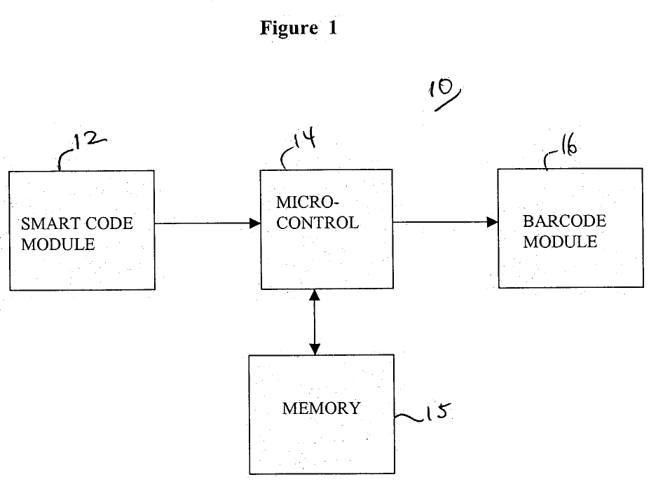

Referring to FIG. 1, in the broadest embodiment, the unit 10 comprises of a smart card reader interface module 12, a programmable microcontroller 14 in association with a memory 15 and a barcode reader module 16. The purpose of the unit is to read and store barcode UPC codes on the file system of a smart card. A simple application of the present invention enables consumers to scan products after use to be added to their grocery list. Such a smart card could comprise a customer loyalty card provided by the grocery store to the consumer. This data could later be retrieved at a kiosk located at the grocery store, for example. A kiosk application would provide the consumer with a printed shopping list, location in the store, prices and alternative products on sale.

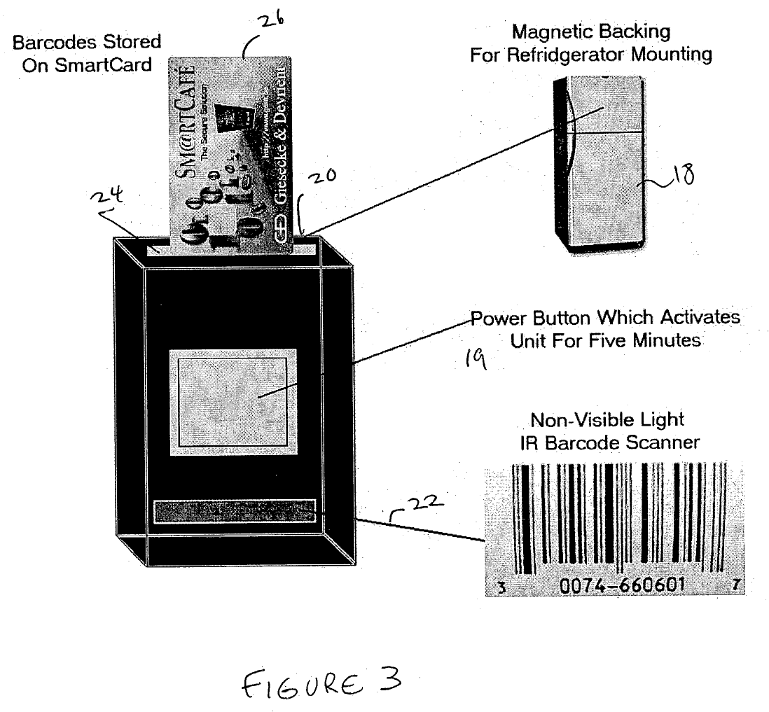

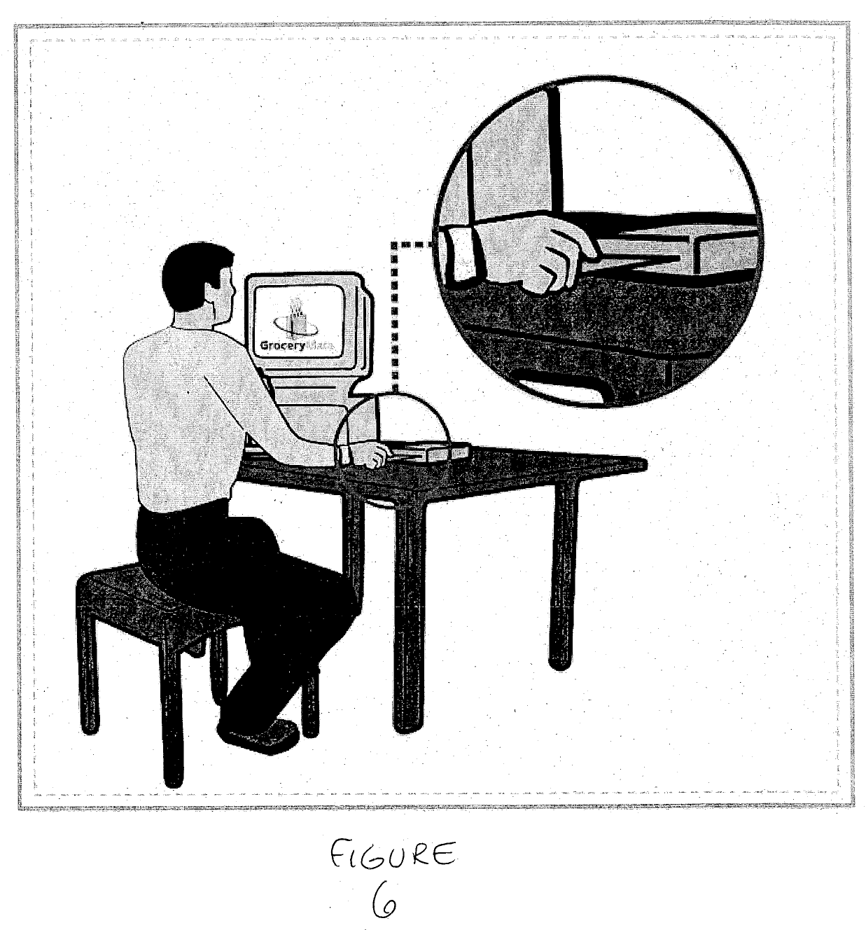

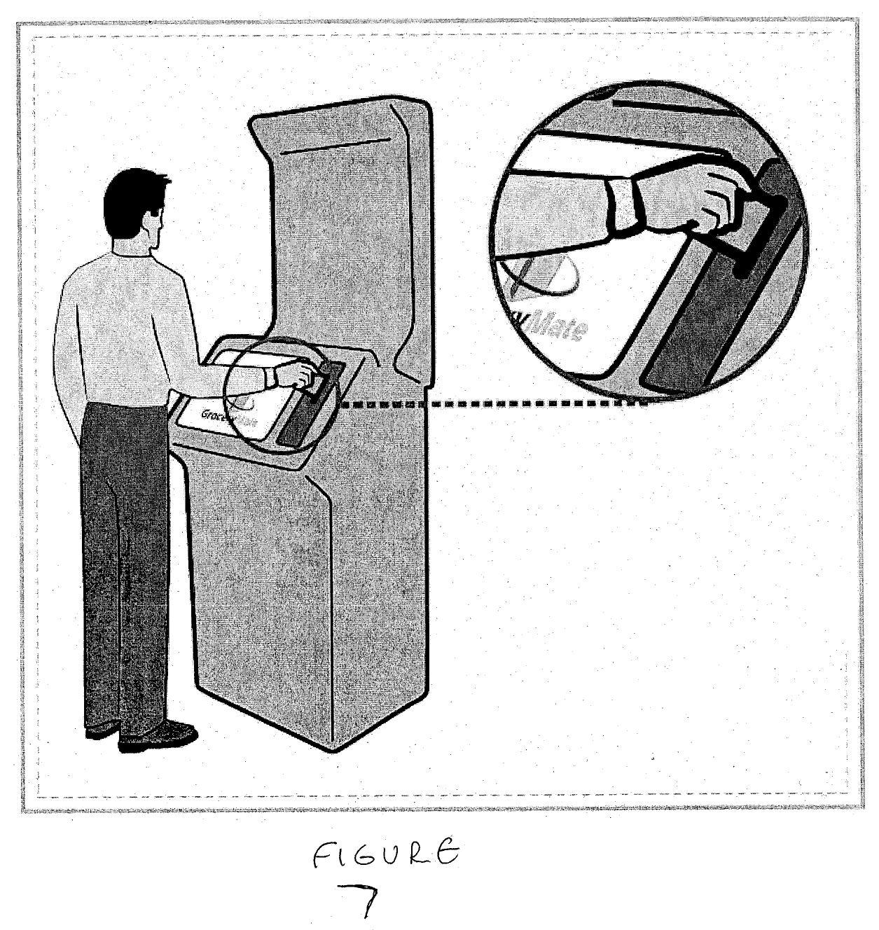

The smart card barcode reader is, in a more preferred embodiment, a programmable microcontroller based system for providing communication between the devices, is intended to scan the barcodes and store in smart card. In the embodiment shown in FIG. 3, the invention may be a hand held unit which integrates smart card and barcode ready technology. The unit, in the most preferred embodiment, comprises smart card reader interface 10, a programmable microcontroller 12, and a barcode reader module 14 of FIG. 1. The unit functions to store barcode UPC codes on a file system within the smart card. Consumers may scan products after use to be added to a grocery list which forms a UPC code data stored on the smart card. Referring to FIGS. 6 and 7, a kiosk application will provide the consumer with a printed shopping list, location in the store, prices and products on sale. A PC interface 15 would allow users to view product data and purchase the items online through an ecommerce site.

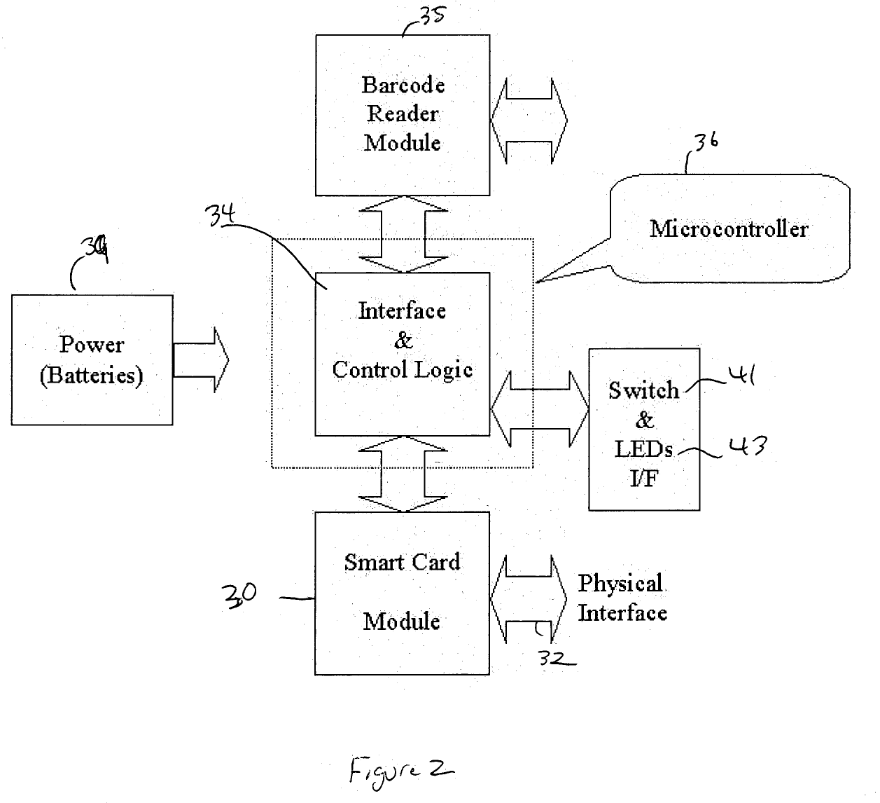

As shown in the embodiment of FIG. 3, incorporating the elements of FIGS. 1 or 2 (to be described below), the invention would comprise a simple unit which could attach to the refrigerator 18 by a magnetic backing 20. The unit would include a power button 19 which actives the unit for a period of time, for example, five minutes. The system would further have a IR barcode scanner 22. The system would further incorporate a slot 24 in which a smart card 26 could be inserted and downloaded with barcode information read into the scanner.

Referring to FIG. 2 is a block diagram of the present invention is more specifically shown. As can be seen, the unit comprises a smart card module 30, and interface 32. It is through this module that the smart card is input. The system further comprises interface and control logic 34. The system further comprises a barcode reader module 35 into which a barcode number is read. The number may be scanned or input by a keypad. Finally, the system further comprises a microcontroller 36 under the control of the interface and control logic 34 and is powered by batteries 39. The system also includes a switch 41 and LED's 43 to read the bar code

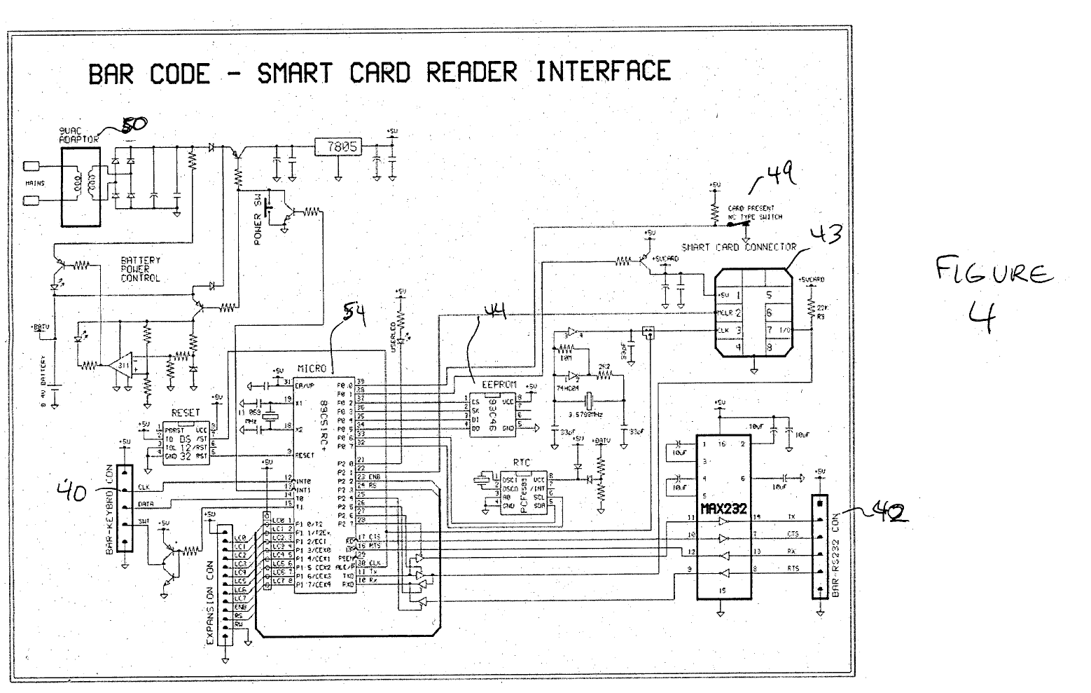

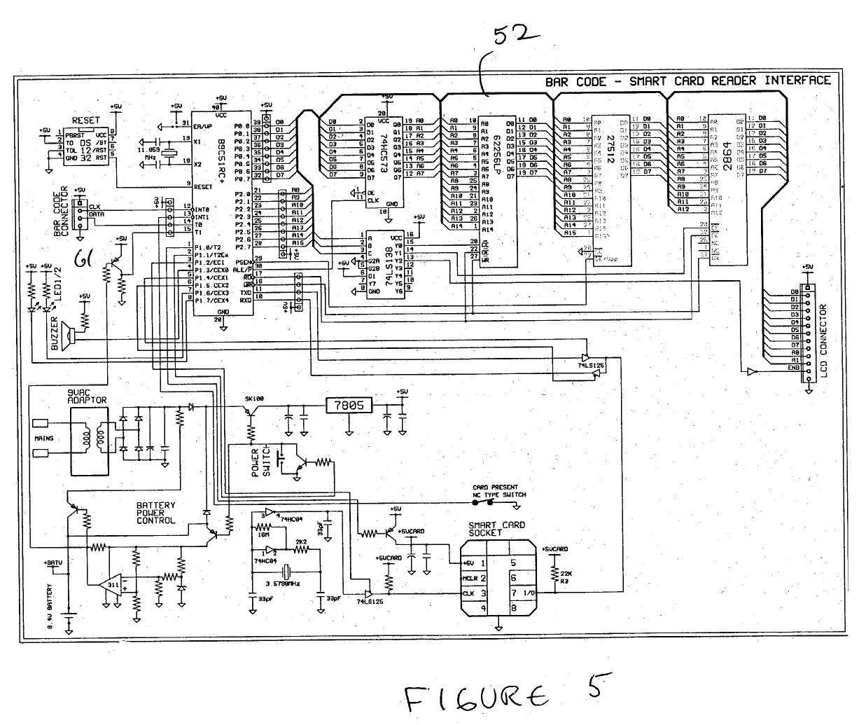

Referring to FIGS. 4 and 5, two embodiments of the invention are shown in schematic form for the smart card barcode reader with the present invention. As shown in FIG. 4, a circuit diagram of the first embodiment is shown. As can be seen, the circuit comprises a barcode reader 42 plus keypad entry 40 which keys a barcode number in the absence of a scanner. The barcode scanner incorporates a MAX 232 barcode reader 51. The scanner can read and convert barcodes to digital signals. This unit should preferably read and decode all required barcode symbologies (e.g., Code 39, Full ASCII Code 39, 2 OF 5, UPC/EAN/JAN, Code-128, Code-93, Codabar, Chinese post code) into corresponding ASCII and/or alphanumeric formats.

A smart card connector 43 with reader technology is also shown. The unit stores interface and control logic 44 which is activated upon by microcontroller 54. In this embodiment, a proposed microcontroller 54 may comprise the 89C51 RC microcontroller. This component should be capable of controlling and synchronizing the barcode unit 40, 42 and the smart card module 43.

Microcontroller 54 reads the input, decodes the barcode data into a corresponding ASCII equivalent and store the barcode data in memory (EPROM 44). Upon a proper “read” operation of the barcode, this component outputs the digital barcode data in ASCII format from memory for appending it on the smart card. A beep may be sounded for both the “read” and “write” process to inform the user of successful operation and suitable LEDs may be used as indicators for the same.

The synchronization of the barcode unit 40, 42 and smart card unit 43 is handled by the microcontroller module 54 in firmware. This element reads the ASCII data inputted from barcode processing unit and stores it in an on-board EPROM 44. The EPROM 44 stores the barcodes which are then written onto the smart card. Alternates to an EPROM 53 may be used in the present invention.

When a smart card is inserted in a card slot 49, it signals the smart card unit to check the smart cards' authenticity. If the card is authenticated, the data in EPROM 44 is transferred via the smart card unit onto the smart card. On successful operation of both the units, appropriate signals are generated and suitable LEDs 61 are lit and a beep is generated. It then accepts data given by microcontroller module from the EPROM 44 and writes the data on the smart card. This module is also responsible for checking the available memory on the smart card. The circuit further utilizes a 9 volt AC 50 adapter for voltage control. The system also comprises a reset button.

In an alternative embodiment of FIG. 5, the system incorporates the same smart card technology. In this particular situation, instead of the MAX 232, the system incorporates a plurality of microcircuits 52 including a 285427512, 62256LP microcontroller. These circuits perform the functions of the MAX 232. The system similarly has a keypad connector for directly typing in barcode numbers. An LED circuit with barcode scanner is provided as well. The system should be scaled to read barcodes at a distance of 12 inches.

In summary, the main functions performed by the present invention are as follows: First, to read barcodes from the products, decode barcode data in ASCII format, and store the ASCII data in memory. Second, to authenticate the smart card, write the barcodes on the smart card, synchronize the functioning of barcode reader and smart card module, indicate successful/unsuccessful read and write operations, check power of the battery and indicate the same.

The present invention suggests a number of business applications. For example, the present invention can be utilized for consumer royalty or premium programs. When a consumer buys various products, the barcode can be read onto the consumer's smart card which then can be redeemed for premium tokens. The account can be quickly updated by updating the barcode entries into a special section of the website. The present invention further provides a level of security for lenders and promoters.

A critical feature of the invention is that it can be utilized across individual vendors and service providers. Accordingly, web vendors, service providers, retailers, etc. can form coops or clubs around a specific smart card.

The present invention has provider applicability to inventory control systems. For example, restaurant employees could scan foods that are being used so that suppliers can know when food inventory needs to be replenished.

The present invention has been described with reference to the enclosed figures wherein the same numbers are utilized where applicable. It is to be appreciated that the true nature and scope of the present invention is to determined with reference to the claims appended hereto.

1. An apparatus for reading and storing barcodes on a smart card comprising,
a housing unit containing therein;
activation means for turning the unit on;
barcode reading means for reading a barcode into the unit;
means for storing the barcodes; and
means for writing the barcodes so stored in the unit onto a smart card.

2. The apparatus according to claim 1 further comprising a means for affixing the housing unit onto a wall.

3. A system for reading a barcode and storing the same onto a smart card comprising;
a barcode reader module for reading a barcode;
a smart card module including a card interface for transcribing a barcode read from said barcode reader module onto a smart card;
a microcontroller under the control of interface and control logic for reading said barcode, storing same; and
means for writing said barcode onto said smart card.

4. The system of claim 3 wherein said barcode reader module comprises an interface for allowing said barcode to be keyed in by keypad means.

5. A system for reading a barcode and storing the same onto a smart card for a consumer loyalty program comprising:
a barcode reader module for reading a barcode off of a product;
a smart card module including a card interface for transcribing a barcode read from said barcode reader module onto a smart card; and
a microcontroller under the control of interface and control logic for reading said barcode, storing same; and
means for writing said barcode onto said smart card.

6. The system of claim 3 wherein said barcode reader module further comprises an interface for allowing said barcode to be keyed in by keypad means.
